(19) United States
(12) Patent Application Publication
(10) Pub. No.: US 2009/0061791 A1
(43) Pub. Date: Mar. 5, 2009

(54) Diversity control method

(75) Inventor: Hiroyuki Matsubara, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/231,093

(22) Filed: Aug. 29, 2008

(30) Foreign Application Priority Data
Sep. 4, 2007 (JP) P2007-228979

(51) Int. Cl. H04B 1/44

(52) U.S. Cl. 455/78

(57) ABSTRACT

A diversity control method of selecting a plurality of antennas having directivities and disposed in different directions is disclosed. At least two antennas are selected from the plurality of antennas. First diversity control of comparing strengths of reception powers of the selected at least two antennas is performed. One antenna having a stronger reception power than others is selected. If the radio conditions of at least two antennas have deteriorated in the first diversity control, second diversity control of comparing radio conditions of at least two antennas is performed in a predetermined period and at least one of the antennas is changed to another new antenna based on a compared result.

### CROSS REFERENCES TO RELATED APPLICATIONS

The present invention contains subject matter related to Japanese Patent Application JP 2007-228979 filed in the Japanese Patent Office on Sep. 4, 2007, the entire contents of which being incorporated herein by reference.

### BACKGROUND OF THE INVENTION

1. Field of the Invention

The present invention relates to a diversity control method used, for example, by a radio apparatus that has, for example, a plurality of directional antennas.

2. Description of the Related Art

In radio systems (eg, wireless local area network (LAN)), a diversity control method that switches one to another of a plurality of antennas has been used for better quality communication. The diversity control can suppress deterioration of transmission quality, for example, against multipath fading. In addition, it allows a radio system to have resistance against interference with another radio system and the range of which the radio system affects other radio systems to narrow. For example, the following Japanese Patent Application Laid-Open No. 2005-210648 Publication (hereinafter referred to as patent document 1) discloses a method of properly controlling a plurality of different directional antennas using diversity control.

Diversity control features a selection algorithm of selecting an optimum antenna from a plurality of antennas. Diversity control of the related art can be categorized as the following two methods. In the first method, an optimum antenna is selected for each packet (hereinafter, this method is sometimes referred to as hardware diversity control).

Next, with reference to FIG. 1, hardware diversity control will be described. FIG. 1 shows an exemplary packet structure of a wireless LAN. Each packet starts with a preamble signal, followed by information including length, rate, and identification of the packet. Each packet ends with data. In FIG. 1, GI represents a guard interval (idle period).

The preamble signal starts with continuous waves having the identical frequency (these waves are referred to as fixed waveforms). The period of the fixed waveforms is, for example, 8 μs.

When packets are received in the wireless LAN, the reception powers of the plurality of antennas are compared for each packet. With the antenna having a stronger reception power than the other, settings for those including reception automatic gain control (AGC), coarse/fine automatic frequency controls (AFCs), and timing are performed. In hardware diversity control, with the fixed waveforms with which each packet starts, an optimum antenna is selected in a short period of each packet and data are received.

The second diversity control method is a method of selecting an optimum antenna by software calculation based on information including packet error rate of each antenna in a predetermined period (hereinafter, this method is sometimes referred to as software diversity control).

### SUMMARY OF THE INVENT ION

Hardware diversity control has a benefit of which antennas having better radio conditions than other can be continuously selected in a short period of each packet. However, since the period of fixed waveforms is short, it is insufficient to determine radio environments of many antennas. Thus, it is difficult to control them. If the period of fixed waveforms is prolonged, although many antennas can be controlled, the throughput will decrease.

If high quality video data (eg, television broadcast) are radio-transmitted, since the data amount is large, it is preferred that the period of fixed waveforms be shorten for high throughput. Thus, in hardware diversity control, two antennas are generally used. However, if two antennas are used, it is necessary to use wide directional antennas having, for example, a semi-sphere surface. Thus, the antennas are subject to be interfered with another radio system.

On the other hand, software diversity control has an advantage of which many antennas can be controlled. However, in software diversity control, it is difficult to optimally select an antenna for each packet. Thus, since it takes a time to select an antenna to some extent, if a disturbance or an obstruction suddenly occurs, continuous packet errors will result in. If high quality video data are radio-transmitted, radio transmission errors of several packets may cause fatal quality deterioration such as image suspension.

In view of the foregoing, it would be desirable to provide a diversity control method that allows radio transmission to be stably performed without a decrease of throughput.

According to an embodiment of the present invention, there is provided a diversity control method of selecting a plurality of antennas having directivities and disposed in different directions. At least two antennas are selected from the plurality of antennas. First diversity control of comparing strengths of reception powers of the selected at least two antennas is performed. One antenna having a stronger reception power than others is selected. If the radio conditions of at least two antennas have deteriorated in the first diversity control, second diversity control of comparing radio conditions of at least two antennas is performed in a predetermined period and at least one of the antennas is changed to another new antenna based on a compared result.

According to an embodiment of the present invention, with a selected antenna of a plurality of directional antennas, first diversity control (hardware diversity control) is performed. If radio condition of the antenna for which hardware diversity control is performed deteriorates, another new antenna is effectively selected by second diversity control (software diversity control). Thus, radio transmission can be stably performed without a decrease of throughput. As a result, when high quality video data are radio-transmitted, quality deterioration of the video data can be decreased.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram showing an exemplary structure of a packet;

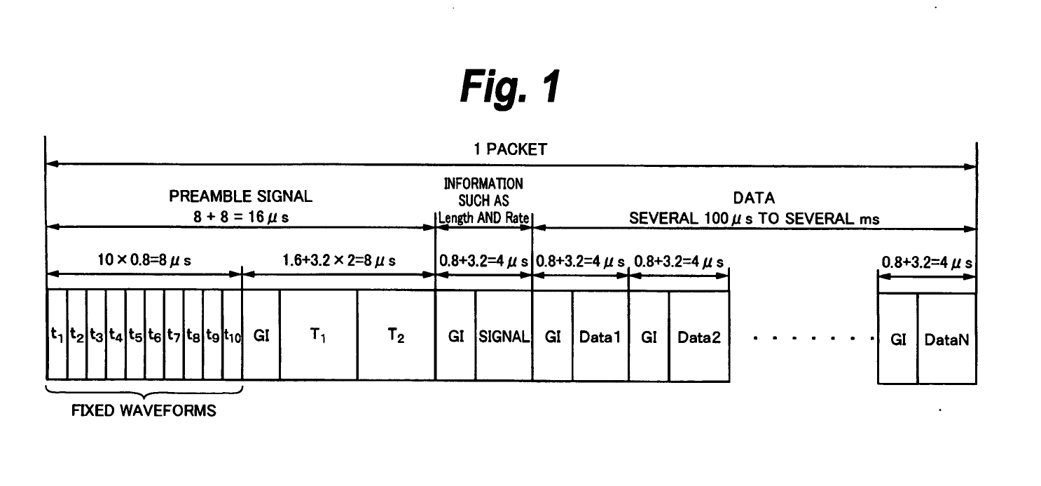

FIG. 2 is a schematic diagram showing an overall structure of a wireless LAN system to which a diversity control method according to an embodiment of the present invention is applicable;

FIG. 3 is a schematic diagram describing a structure of antennas of a radio base station and a diversity control method according to an embodiment of the present invention;

FIG. 4 is a schematic diagram describing a structure of antennas of a radio terminal and a diversity control method according to an embodiment of the present invention;

FIG. 5 is a block diagram showing an overall structure of a radio base station according to an embodiment of the present invention;

FIG. 6 is a block diagram showing an overall structure of a radio terminal according to an embodiment of the present invention;

FIG. 7 is a flow chart describing a flow of a transmitting process of a radio base station according to an embodiment of the present invention;

FIG. 8 is a flow chart describing a flow of a transmitting process of a radio base station according to an embodiment of the present invention; and

FIG. 9 is a flow chart describing a flow of a receiving process of a radio terminal according to an embodiment of the present invention.

### DETAILED DESCRIPTION OF THE PREFERRED EMBODIMENTS

Next, with reference to the accompanying drawings, embodiments of the present invention will be described. Diversity control methods according to embodiments of the present invention are applicable to a free-location visual audio system (having a place shift function) that is referred to, for example, as location free (registered trade mark of Sony Corporation) and with which the user can watch and listen to content (eg, television broadcasts). The place shift visual audio system is composed of at least a base station as a content transmitting device and a content receiving device (also referred to as a location free player or a client) that provides video and audio data to the user who watches and listen to them.

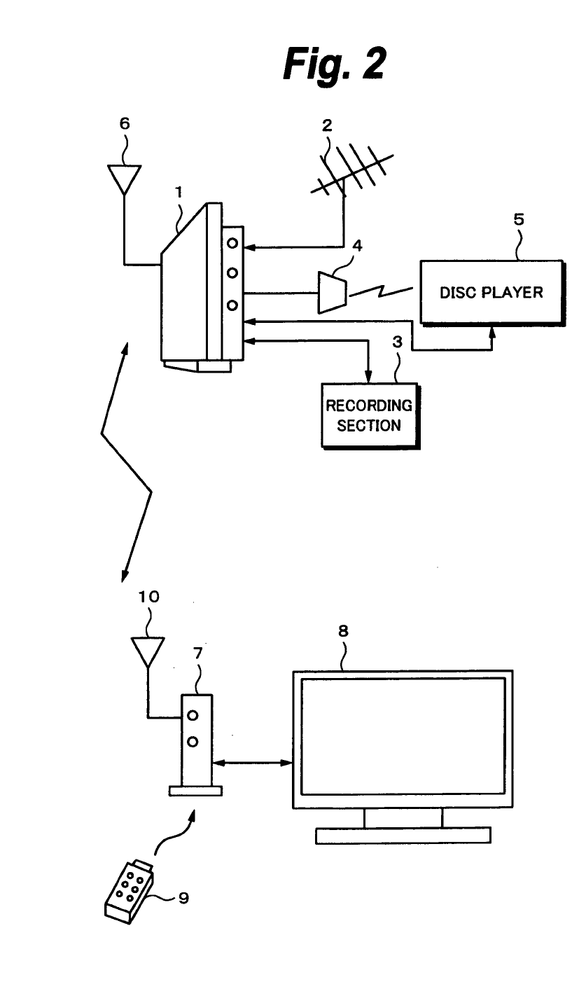

First, with reference to FIG. 2, a structure of a content transmitting and receiving system using a wireless LAN will be described in brief. A television antenna 2 is connected to a base station 1 as a content transmitting device such that the base station 1 can receive television broadcasts (eg, analog television broadcasts). Broadcast content such as satellite digital broadcast programs, ground digital broadcast programs, cable television programs, an Internet television program, and the like may be received as well as analog television broadcast programs.

In addition, a disc player 5 (eg, a digital versatile disc (DVD) player, a Blu-ray Disc (BD) player) is connected to the base station 1. The disc player 5 can output a standard definition (SD) video or a high definition (HD) video recorded on a disc to the base station 1 according to an external control command.

Channel selections of broadcast programs sent from the base station 1 and operations of the disc player 5 can be remotely controlled by a receiving device (eg, a location free player, a client). For example, an AV mouse 4 is connected to the base station 1 such that the operations of the disc player 5 can be remotely controlled by the receiving device.

The base station 1 has a sector antenna 6. The sector antenna 6 and a sector antenna 10 of a TV box 7 forms a wireless LAN. Data of which, for example, broadcast content received by the base station 1 or a reproduced video of the disc player 5 has been compressed are transmitted to the TV box 7 through the wireless LAN. The data are packetized and transmitted. The wireless LAN systems are based on three standards of IEEE 802.11b/g/a.

The sector antenna 6 and the sector antenna 10 each have a plurality of directional antennas, one of which is selected and used to obtained a desired directivity. The structures of the sector antenna 6 and the sector antenna 10 will be described later.

The TV box 7 as a content receiving device is connected to the wireless LAN. The TV box 7 decodes data of broadcast content received through the wireless LAN and outputs the decoded data as an analog video audio signal. The analog video audio signal is supplied to a display 8 (eg, a video input terminal of a television receiver). With the display 8, the user can watch and listen to television broadcast programs transmitted from the base station 1.

The TV box 7 decodes reproduced video data of the disc player 5 received through the wireless LAN and outputs the decoded data as digital video audio signals. The digital video audio signals are supplied to an input terminal of the display 8. With the display 8, the user can watch and listen to an HD video and so forth sent from the base station 1.

The TV box 7 can be remotely controlled by a remote control commander 9.

With the display 8, the user can watch and listen to broadcast programs sent from the base station 1. In addition, with the function of the TV box 7, the display 8, and the commander 9, data for setting the base station 1 and the disc player 5 connected thereto can be formed and these devices can be remotely controlled.

When the television antenna 2 and the disc player 5 are connected to the base station 1 in such a manner, the user can watch and listen to a television broadcast program that is being broadcast or a reproduced video and so forth of the disc player 5 through the wireless LAN in any room of the house. In the following description, in the wireless LAN system, the side like the base station 1 that transmits data (eg, a reproduced video) is sometimes referred to as the radio base station, whereas the side like the TV box 7 that receives data 9 (eg, a reproduced video and so forth) is sometimes referred to as the radio terminal.

According to an embodiment of the present invention, in diversity control of the sector antenna 6 of the radio base station and the sector antenna 10 of the radio terminal, hardware diversity control and software diversity control are used in combination.

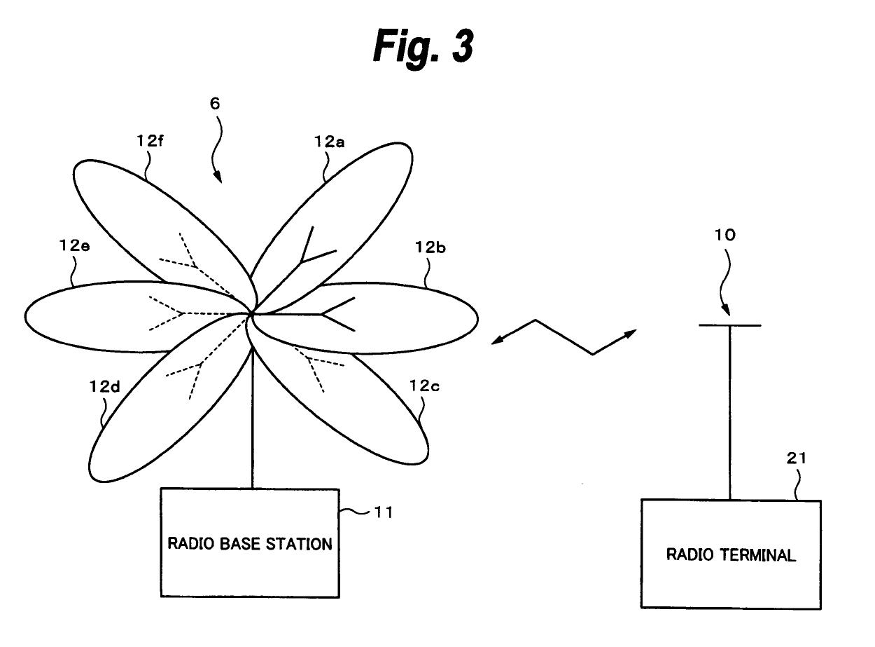

Next, the structures of the sector antenna 6 and the sector antenna 10 and diversity control will be specifically described. First, with reference to FIG. 3, the structure of the sector antenna 6 of the radio base station 11 will be described. In FIG. 3, the structure of other than the sector antenna 6 is simply illustrated.

As shown in FIG. 3, the sector antenna 6 of the radio base station 11 is composed of six directional antennas 12a, 12b, 12c, 12d, 12e, and 12f (hereinafter, they are referred to as antennas 12 if they do not represent specific antennas). These antennas 12 are disposed such that they divide the space area into six sectors. These antennas 12 have different directivities. With the arrangement of the antennas 12, directivities that almost cover all the directions of 360° can be obtained.

It should be noted that the number and arrangement of the antennas 12 are not limited to those shown in FIG. 3.

When data (eg, an HD video and so force) are packetized and transmitted from the radio base station 11, an antenna 12 having a good radio condition is selected from the plurality of antennas 12 by diversity control. Next, diversity control of the radio base station 11 will be described.

First, two adjacent antennas 12 are selected as antennas 12 for which hardware diversity control is performed. It is assumed that the two antennas 12 for which hardware diversity control is performed are registered for hardware diversity A and hardware diversity B. For example, the antenna 12a and the antenna 12b are selected and registered for hardware diversity A and hardware diversity B, respectively.

When the radio base station 11 and the radio terminal 21 are correlated in one-to-one relationship (referred to as “paired”), for example, upon start of radio communication, packets are transmitted from the antennas 12 first registered for hardware diversity A and hardware diversity B. An antenna 12 that has a stronger reception power than the other can be selected from the antennas 12 that have succeeded in transmitting them and have received a normal reception acknowledge signal. Pairing means that identification information (IDs) of the radio base station 11 and the radio terminal 21 is exchanged therebetween. As the identification information, IDs (eg, message authentication code (MAC) address), addresses generated from MAC addresses), and so forth can be used.

Upon pairing of the radio base station 11 and the radio terminal 21, pairs of adjacent antennas 12 may be changed in succession clockwise or counterclockwise. A pair of antennas 12 that have succeeded in transmitting packets may be registered for hardware diversity A and hardware diversity B.

Of the antennas 12 registered for hardware diversity A and hardware diversity B, an antenna 12 that has a better radio condition than the other is registered as an antenna that transmits a packet (ie, the transmitting antenna). If the determined result denotes that the antenna 12a has a better radio condition than the antenna 12b, the antenna 12a is selected as the transmitting antenna. The transmitting antenna is selected by software diversity control. Software diversity control can be performed on the basis of the results of software calculations of radio information (eg, histories of packet counts that have been normally received) of the individual antennas 12 in a predetermined period.

Thereafter, with the antenna 12a selected as the transmitting antenna, a packet is transmitted. The transmitted packet is received through the sector antenna 10 of the radio terminal 21. If the radio terminal 21 has correctly received a packet, a normal reception acknowledge signal is transmitted from the sector antenna 10 of the radio terminal 21.

The radio base station 11 receives the normal reception acknowledge signal with an antenna having a stronger reception power in those registered for hardware diversity A or hardware diversity B. In other words, received signal strength indicators (RSSIs) of the normal reception acknowledge signals received by the antenna 12a and the antenna 12b are compared for each packet and an antenna 12 having a larger RSSI than the other is selected and used.

A packet is transmitted from the antenna 12a selected as the transmitting antenna. Thereafter, if the transmitting antenna does not receive the normal reception acknowledge signal, a packet is transmitted again from the antenna 12a (this operation is referred to as transmission retry). In the transmission retry, the antenna used as the transmission antenna of those registered for hardware diversity A and hardware diversity B is changed whenever one or two packets are transmitted. The transmitting antenna is changed in the order of, for example, antenna 12a→antenna 12a→antenna 12b→antenna 12b→antenna 12a and so forth.

If the current transmission retry count has become larger than the transmission retry count threshold, it is assumed that the antenna 12a and the antenna 12b have bad radio conditions and the antennas 12 registered for hardware diversity A and hardware diversity B are changed. This changing process is performed by software diversity control. The transmission retry count threshold is, for example, 5 to 10.

If the results of the software calculations denote that the antenna 12a has a worse radio condition than the antenna 12b, the antenna 12a registered for hardware diversity A is changed to a new antenna 12 different from the antenna 12a and the antenna 12b. As a new antenna 12, for example the antenna 12c adjacent to an antenna (eg, the antenna 12b) having a better radio condition of the antenna 12a and the antenna 12b is selected. This is because a new antenna 12 adjacent to an antenna 12 having a better radio condition is likely to have a better radio condition. Thereafter, radio communication is performed with the antenna 12b and the new antenna 12c registered for hardware diversity A and hardware diversity B, respectively.

Instead, both antennas 12 registered for hardware diversity A and hardware diversity B may be changed to other new antennas 12. In this case, if the antenna 12a has a worse radio condition than the antenna 12b, new antennas (eg, the antenna 12c and the antenna 12d) adjacent to the antenna (eg, the antenna 12b) having a better radio condition can be selected as those having better radio wave environments.

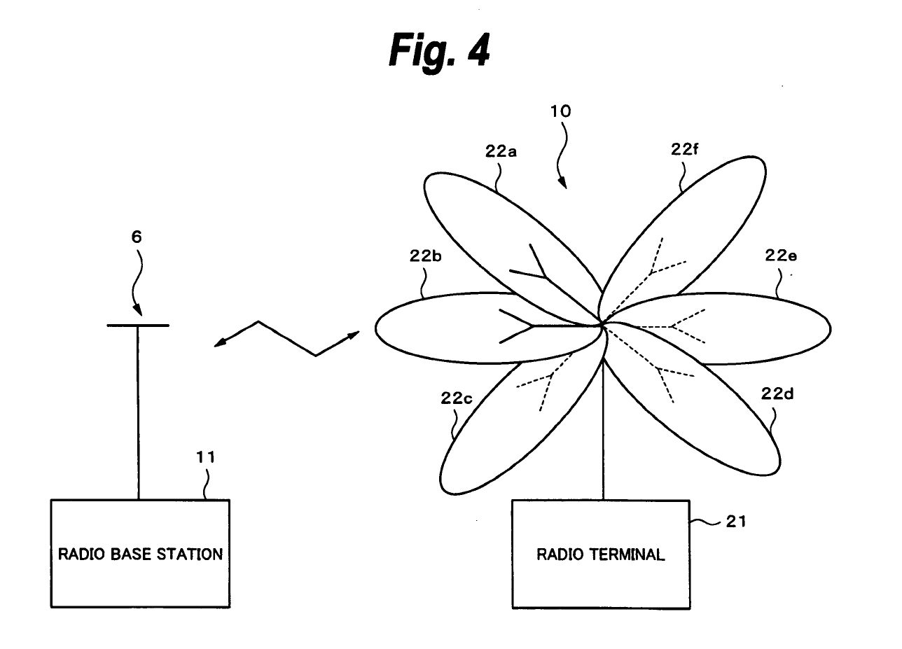

Next, with reference to FIG. 4, the structure of the sector antenna 10 of the radio terminal 21 and diversity control will be specifically described. In FIG. 4, the structure of other than the sector antenna 10 is simply illustrated.

As shown in FIG. 4, like the sector antenna 6 of the radio base station 11, the sector antenna 10 of the radio terminal 21 is composed of six directional antennas 22a, 22b, 22c, 22d, 22e, and 22f (they are referred to as antennas 22 if they do not represent specific antennas). The arrangement and structure of the antennas 22 are the same as those of the antennas 12 of the radio base station 11.

When the radio terminal 21 receives data (eg, an HD video and so forth) from the radio base station 11, an antenna 22 having a better radio condition than other is selected from a plurality of antennas 22 by diversity control. Next, diversity control of the radio terminal 21 will be described.

First, as antennas 22 for which hardware diversity control is performed, two adjacent antennas 22 are selected from the six antennas 22. For example, the antenna 22a and the antenna 22b are selected and registered for hardware diversity A and hardware diversity B, respectively.

The antennas 22 first registered for hardware diversity A and hardware diversity B can be selected in the same manner as those of the radio base station 11.

The radio terminal 21 receives a packet from the radio base station 11 with an antenna 22 having a stronger reception power than the other in the antennas 22 registered for hardware diversity A and hardware diversity B by hardware diversity control. In other words, RSSIs of signals received by the antenna 22a and the antenna 22b are compared for each packet and an antenna having a larger RSSI than the other is selected.

If the current successive reception failure count of a packet that is received has become larger than the successive reception failure count threshold, it is assumed that these antennas 22 have bad radio conditions and antennas 22 registered for hardware diversity A and hardware diversity B are changed to other antennas 22. The successive reception failure count threshold is, for example, 5 to 10. This changing process is performed by software diversity control.

The successive reception failure count can be obtained by using, for example, cyclic redundancy check (CRC) to detect successive errors.

If the results of the software calculations denote that the antenna 22a has a worse radio condition than the antenna 22b, the antenna 22a registered for hardware diversity A is changed to a new antennas 22 different from the antenna 22a and the antenna 22b. As the new antenna 22, an antenna (eg, the antenna 23c) adjacent to an antenna (ie, antenna 22b) having a better radio condition than the other in the antenna 22a and the antenna 22b is selected. Thereafter, with the antenna 22b and the new antenna 22c registered for hardware diversity A and hardware diversity B, respectively, radio communication is performed.

Instead, both the antennas 22 registered for hardware diversity A and hardware diversity B may be changed to other new antennas 22.

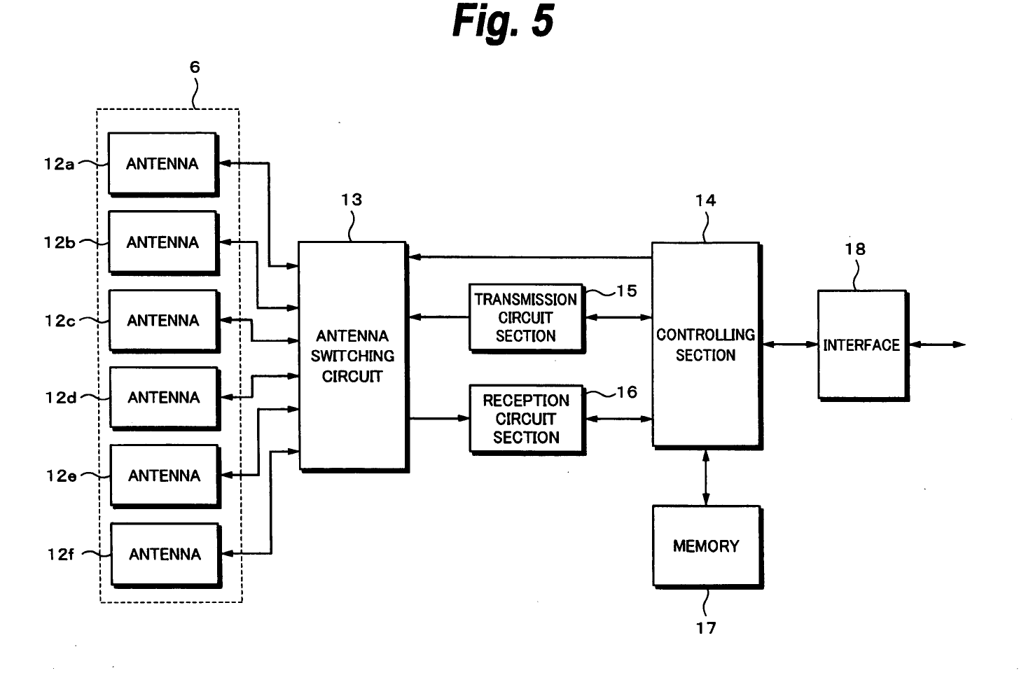

FIG. 5 is a block diagram showing an overall structure of the radio base station 11. The antennas 12 of the radio base station 11 are switched by an antenna switching circuit 13. With the selected antenna 12, a packet is transmitted and received.

The antenna switching circuit 13 switches ON/OFF of the antennas 12 according to an antenna switch signal received from a controlling section 14.

The controlling section 14 is composed, for example, of a digital signal processor (DSP) that can perform a calculating process. The controlling section 14 decides antennas 12 including those registered for hardware diversity A and hardware diversity B and those with which a packet is transmitted and received, and sends the antenna switch signal to an antenna switching circuit 13. The process of selecting antennas 12 is performed by a software diversity processing section and a hardware diversity processing section of the controlling section 14.

The software diversity processing section of the controlling section 14 performs software calculations for radio information (eg, transmission retry count, normally received packet count) of the individual antennas 12. If the current transmission retry count is larger than the transmission retry count threshold, the software diversity processing section sends the antenna switch signal to the antenna switching circuit 13. Thus, the antennas 12 registered for hardware diversity A and hardware diversity B are changed to other new antennas 12.

The hardware diversity processing section of the controlling section 14 compares the strengths of the reception powers (RSSIs of the reception signals) of the antennas 12 registered for hardware diversity A and hardware diversity B, selects an antenna 12 having a larger RSSI than the other, and sends the antenna switch signal to the antenna switching circuit 13. RSSIs are supplied from a reception circuit section 16. This hardware diversity process is performed during a period of fixed waveforms (preamble signal) at the beginning of each packet.

In addition, the controlling section 14 outputs compression-encoded data (eg, an HD video and so forth) supplied from an interface 18 to a transmission circuit section 15.

Compression-encoded data are supplied from the controlling section 14 to the transmission circuit section 15. The transmission circuit section 15 includes a radio frequency amplifying circuit and a frequency converting circuit. The transmission circuit section 15 converts the compression-encoded data into a radio frequency signal and transmits the converted radio frequency signal. The transmission data are transmitted from an antenna 12 selected as the transmitting antenna through the antenna switching circuit 13.

A normal reception acknowledge signal is supplied to the reception circuit section 16 from the radio terminal 21 through the selected antenna 12. The reception circuit section 16 includes a radio frequency amplifying circuit, a frequency converting circuit, and an AGC circuit. The reception circuit section 16 receives a radio frequency signal, converts it into an appropriate signal, and performs other predetermined processes. The received signal is supplied to the interface 18 through the controlling section 14.

In addition, after RSSIs of the normal reception acknowledge signals have been obtained by the AGC circuit, the reception circuit section 16 converts them into numeric values and supplies them to the controlling section 14.

A memory 17 is composed of a random access memory (RAM). The memory 17 stores radio information (eg, antennas 12 currently registered for hardware diversity A and hardware diversity B and transmission retry count). These information is properly updated by the controlling section 14 and are used for software diversity control.

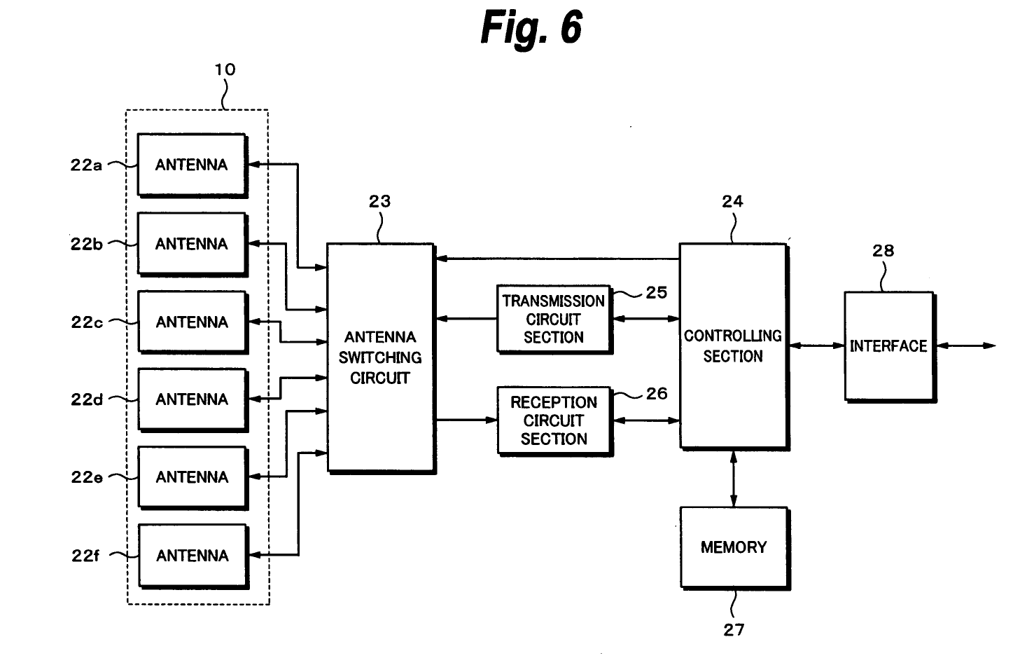

FIG. 6 is a block diagram showing an overall structure of the radio terminal 21. The antennas 22 of the radio terminal 21 are switched by an antenna switching circuit 23. A packet is transmitted and received by the selected antenna 22.

The antenna switching circuit 23 switches ON/OFF of the antennas 22 according to an antenna switch signal supplied from a controlling section 24.

The controlling section 24 is composed of a DSP. The controlling section 24 decides antennas 22 registered for hardware diversity A and hardware diversity B and sends the antenna switch signal to the antenna switching circuit 23. The process of selecting the antennas 22 is performed by a software diversity processing section and a hardware diversity processing section of the controlling section 24.

The software diversity processing section of the controlling section 24 performs software calculations for radio information (eg, successive reception failure count, normally received packet count) of the individual antennas 22. If the current successive reception failure count is larger than the successive reception failure count threshold, the software diversity processing circuit sends the antenna switch signal to the antenna switching circuit 23. Thus, the antennas 22 registered for hardware diversity A and hardware diversity B are changed to other new antennas 22.

The hardware diversity processing section of the controlling section 24 compares the strengths (RSSIs of reception signals) of reception powers of the antennas 22 registered for hardware diversity A and hardware diversity B, selects an antenna 22 having a stronger reception power than the other, and sends the antenna switch signal to the antenna switching circuit 23. RSSIs are supplied from a reception circuit section 26. The hardware diversity process is performed during a period of fixed waveforms (preamble signals) at the beginning of each packet.

In addition, the controlling section 24 sends the data supplied from the reception circuit section 26 to an interface 28. In addition, the controlling section 24 sends a signal supplied through the interface 28 to a transmission circuit section 25.

Signals (eg, normal reception acknowledge signal) are supplied from the controlling section 24 to the transmission circuit section 25. The transmission circuit section 25 has a radio frequency amplifying circuit, a frequency converting circuit, and so forth. The transmission circuit section 25 converts the signal supplied through the interface 28 into a radio frequency signal and transmits it. A normal reception acknowledge signal is transmitted from the selected antenna 22 through the antenna switching circuit 23.

A packet is supplied from the radio base station 11 to the reception circuit section 26 through the antenna 22. The reception circuit section 26 includes a radio frequency amplifying circuit, a frequency converting circuit, an AGC circuit, and so forth. The reception circuit section 26 receives a radio frequency signal and converts it into a predetermine signal. The received data signal is supplied to the interface 28 through the controlling section 24.

After RSSIs of the received signals have been obtained by the AGC circuit, the reception circuit section 26 converts them into numeric values and supplies them to the controlling section 24.

A memory 27 is composed of a RAM. The memory 27 stores radio information (eg, the antennas 22 currently registered for hardware diversity A and hardware diversity B, successive reception failure count). These information is properly updated by the controlling section 24 and is used for software diversity control.

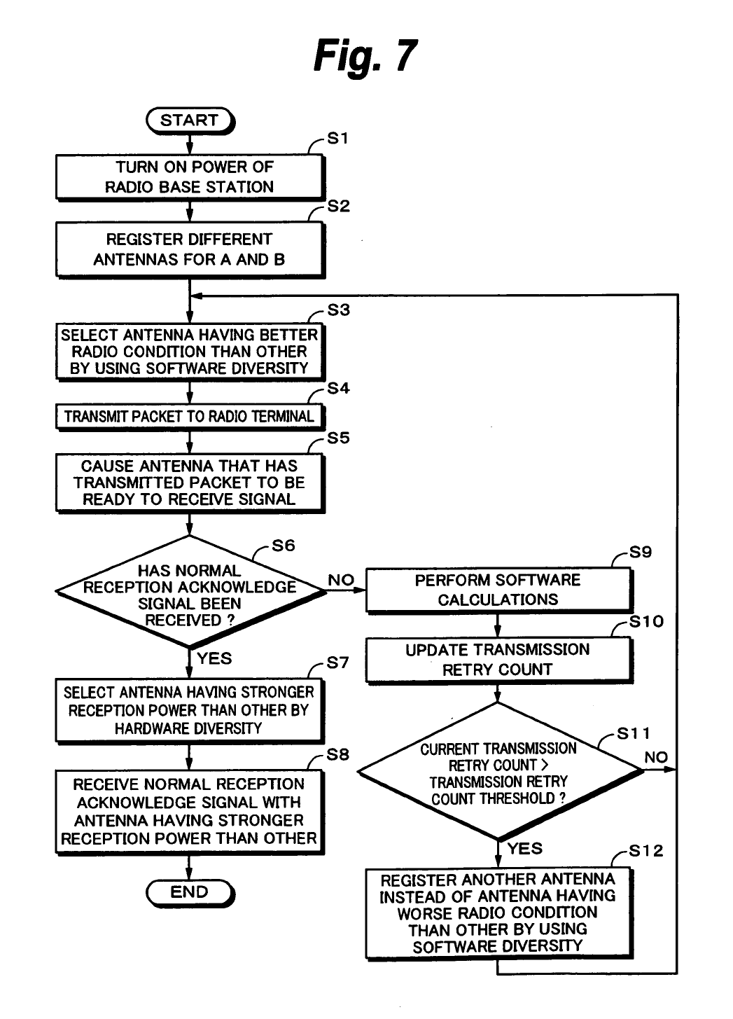

Next, a flow of the diversity control process according to an embodiment of the present invention will be described. FIG. 7 is a flow chart showing a flow of a transmitting process of the radio base station 11. It is assumed that the following process is performed by the controlling section 14 of the radio base station 11 unless otherwise specified.

First, at step S1, the user turns on the power of the radio base station 11. Before step S1, the radio base station 11 and the radio terminal 21 have been paired and connectable.

At step S2, two adjacently directional antennas 12 of six antennas 12 are registered for hardware diversity A and hardware diversity B. As the registered antennas 12, a pair of antennas 12 having large RSSIs of normal reception acknowledge signals against transmission of packets from the antennas 12 can be selected. In FIG. 7, A and B represent hardware diversity A and hardware diversity B, respectively. These notations apply to illustrations preceded by FIG. 7.

Next, at step S3, an antenna 12 having a better radio condition than the other in the antennas 12 registered for hardware diversity A and hardware diversity B is selected as the transmitting antenna. The transmitting antenna is selected on the basis of past reception histories of the individual antennas 12 and so forth by software diversity control. A flow of the software diversity process will be described later.

At step S4, with the antenna 12 selected at step S3, a packet is transmitted to the radio terminal 21.

Next, at step S5, the transmitting antenna 12 that has transmitted a packet is caused to be ready to receive the normal reception acknowledge signal from the radio terminal 21 for a predetermined period.

At step S6, it is determined whether or not the antenna 12 that had transmitted a packet has received the normal reception acknowledge signal in the predetermined period. If the transmitting antenna 12 has received the normal reception acknowledge signal, it is determined that communication with the radio terminal 21 has succeeded. Thereafter, the flow advances to step S7.

At step S7, an antenna 12 having a stronger reception power than the other of the antennas 12 registered for hardware diversity A and hardware diversity B is selected by hardware diversity control.

Thereafter, at step S8, with the antennas 12 selected by hardware diversity control at step S7, the normal reception acknowledge signal is received.

In contrast, if the antenna 12 that had transmitted a packet at step S6 has not received the normal reception acknowledge signal, it is determined that communication with the radio terminal 21 has failed. Thereafter, the flow advances to step S9.

At step S9, the transmission retry count is incremented by 1 by software calculations. Thereafter, at step S10, the transmission retry count is updated.

At step S11, the current transmission retry count is checked such that it is determined whether or not the current transmission retry count is larger than the transmission retry count threshold. If the current transmission retry count is equal to or smaller than the transmission retry count threshold, the flow advances to step S3. At step S3, a packet is transmitted to the radio terminal 21 again. In this case, at step S3, whenever two transmission retries are successively performed, the antenna 12 that transmits a packet is switched to another antenna 12. In other words, if two transmission retries have occurred with the antenna 12 registered for hardware diversity A, the next transmission retry is performed with the antenna 12 registered for hardware diversity B.

If the determined result at step S11 denotes that the current transmission retry count is larger than the transmission retry count threshold, an antenna 12 having a worse radio condition than the other of the antennas 12 registered for hardware diversity A and hardware diversity B is changed to another new antenna 12 by software diversity control. In software diversity control, results of software calculations of radio information of the antennas 12 registered for hardware diversity A and hardware diversity B are used. As another new antenna 12, an antenna 12 adjacent to an antenna 12 having a better radio condition than the other of the antennas 12 registered for hardware diversity A and hardware diversity B can be used.

If a new pair of antennas 12 as those registered for hardware diversity A and hardware diversity B have been registered at step S12, the flow advances to step S3. At step S3, a packet is transmitted to the radio terminal 21 again.

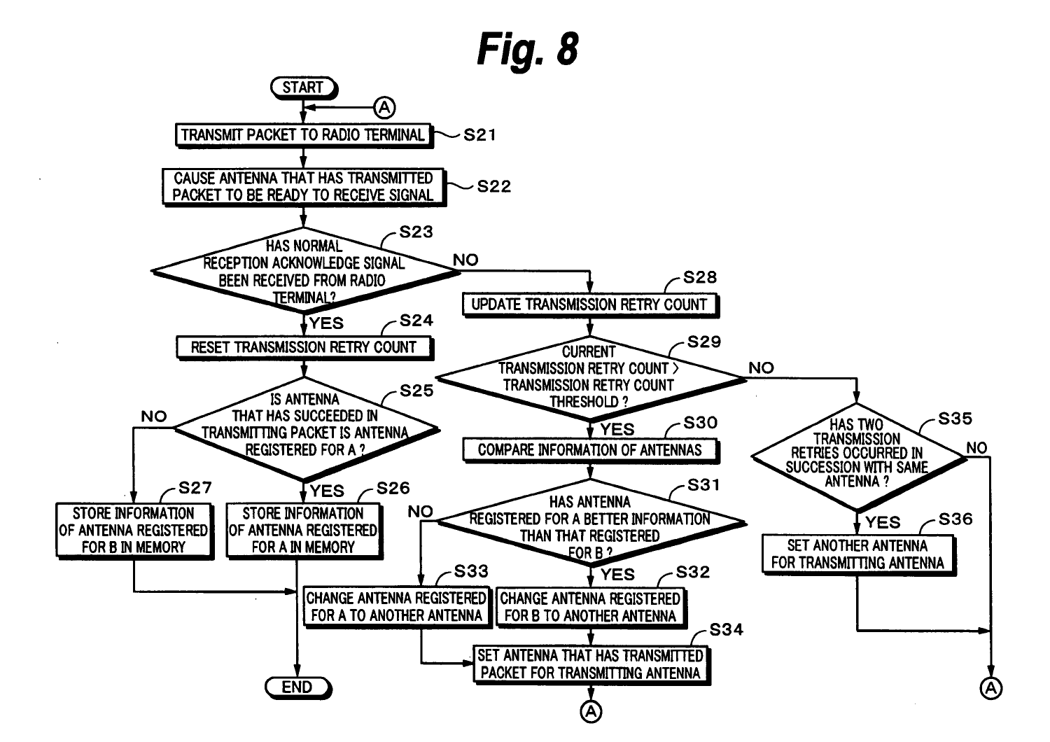

Next, with reference to FIG. 8, a flow of a process of software diversity control performed by the radio base station 11 will be described.

First, at step S21, with an antenna 12 that has been set for the transmitting antenna of the antennas 12 registered for hardware diversity A and hardware diversity B, a packet is transmitted to the radio terminal 21.

Thereafter, at step S22, the antenna 12 that has transmitted a packet is caused to be ready to receive the normal reception acknowledge signal from the radio terminal 21 for a predetermined period.

At step S23, it is determined whether or not the antenna 12 has received the normal reception acknowledge signal in the predetermined period. If the determined result denotes that the antenna 12 has received the normal reception acknowledge signal, the flow advances to step S24.

At step S24, the current transmission retry count stored in the memory 17 is reset.

Thereafter, at step S25, it is determined whether or not the antenna 12 that has succeeded in transmitting a packet is one registered for hardware diversity A. If the determined result denotes that the antenna 12 is one registered for hardware diversity A, the flow advances to step S26.

At step S26, radio information of the antenna 12 registered for hardware diversity A is stored in the memory 17.

If the determined result at step S25 denotes that the antenna 12 that has succeeded in transmitting a packet is not one registered for hardware diversity A, the flow advances to step S27.

At step S27, radio information of the antenna 12 registered for hardware diversity B is stored in the memory 17. The information stored at step S26 and step S27 can be used to select new antennas 12 registered for hardware diversity A and hardware diversity B.

In contrast, if the determined result at step S23 denotes that the normal reception acknowledge signal has not been received, the flow advances to step S28.

At step S28, the transmission retry count is updated by incrementing it by 1.

At step S29, the current transmission retry count is checked and it is determined whether or not the current transmission retry count is larger than the transmission retry count threshold. If the determined result denotes that the current transmission retry count is equal to or smaller than the transmission retry count threshold, the flow advances to step S35.

At step S35, it is determined whether or not two transmission retries have occurred in succession with the same antenna 12. If the determined result denotes that the two transmission retries have not occurred in succession with the same antenna 12, the flow advances to step S21. At step S21, a packet is transmitted to the radio terminal 21 again.

If the determined result denotes that two transmission retries have occurred with the same antenna 12, the flow advances to step S36. At step S36, an antenna 12 different from the antenna 12 that has transmitted a packet of those selected as hardware diversity A and hardware diversity B is set for the transmitting antenna. Thereafter, the flow advances to step S21. At step S21, a packet is transmitted to the radio terminal 21 again.

In contrast, if the determined result at step S29 denotes that the current transmission retry count is larger than the transmission retry count threshold, the flow advances to step S30.

At step S30, radio information (eg, histories of normally received packet counts) of the antennas 12 registered for hardware diversity A and hardware diversity B is compared.

At step S31, it is determined whether or not the antenna 12 registered for hardware diversity A has better radio information than that registered for hardware diversity B. If the determined result denotes that the antenna 12 registered for hardware diversity A has better radio information than that registered for hardware diversity B, the flow advances to step S32.

At step S32, the antenna 12 registered for hardware diversity B is changed to another new antenna 12. In this case, to select an antenna 12 supposed to have a better radio environment, an antenna 12 adjacent to the antenna 12 registered for hardware diversity A is selected. Thereafter, the flow advances to step S34.

In contrast, if the determined result at step S31 denotes that the antenna 12 registered for hardware diversity A has worse radio information than that registered for hardware diversity B, the flow advances to step S33.

At step S33, the antenna 12 registered for hardware diversity A is changed to another new antenna 12. In this case, to select an antenna 12 supposed to have a better radio environment, an antenna 12 adjacent to the antenna 12 registered for hardware diversity B is selected. Thereafter, the flow advances to step S34.

At step S34, the antenna 12 that has been newly registered for hardware diversity A or hardware diversity B at step S32 or step S33 is set for the transmitting antenna. Thereafter, the flow advances to step S21. At step S21, packets are transmitted to the radio terminal 21 again.

At step S34, the antenna 12 newly registered for hardware diversity A or hardware diversity B at step S32 or step S33 is set as the transmitting antenna. Thereafter, the flow advances to step S21. At step S21, a packet is transmitted to the radio terminal 21 again.

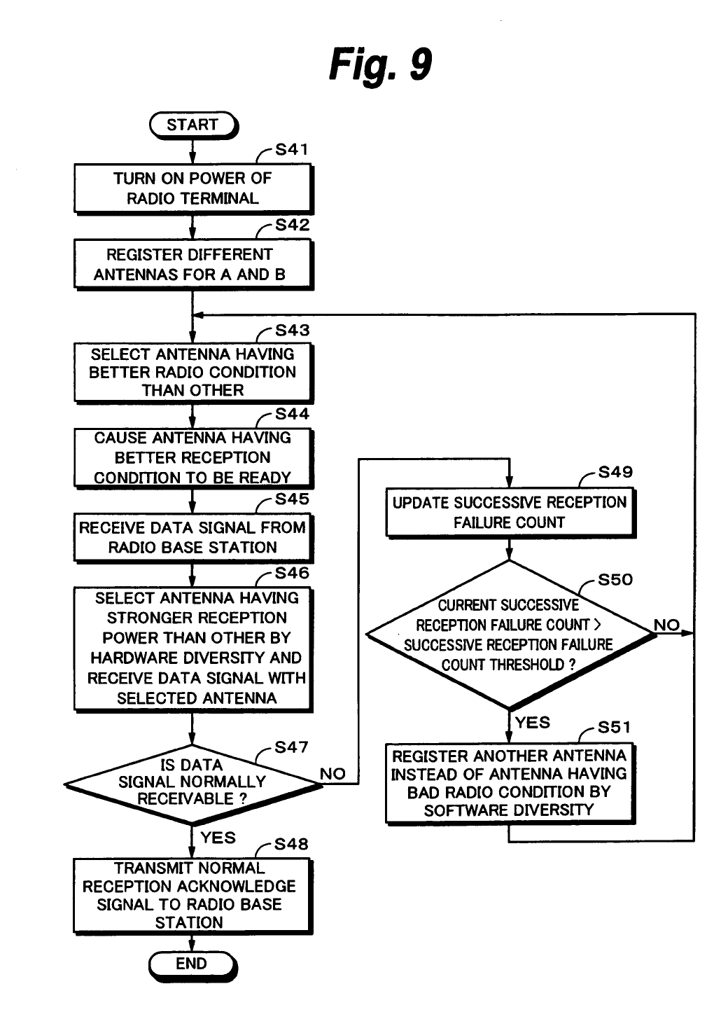

Next, with reference to FIG. 9, a flow of a process of diversity control performed by the radio terminal 21 will be described. It is assumed that the following process is performed by the controlling section 24 of the radio terminal 21.

First, at step S41, the user turns on the power of the radio terminal 21. Before step S41, the radio terminal 21 and the radio base station 11 have been paired and connectable.

At step S42, two adjacently directional antennas 22 of six antennas 22 are registered for hardware diversity A and hardware diversity B. The antennas 22 that are registered can be selected in the same manner as those performed at step S2 shown in FIG. 7.

Thereafter, at step S43, an antenna 22 having a better radio condition than the other of the antennas 22 registered for hardware diversity A and hardware diversity B is selected. The antenna 22 is selected on the basis of past reception histories of the individual antennas 22 and so forth by software diversity control.

Thereafter, at step S44, the antenna 22 having the better radio condition selected at step S43 is caused to be ready to receive a data signal from the radio base station 11.

At step S45, a preamble signal at the beginning of the data signal is received from the radio base station 11.

At step S46, an antenna 22 having a stronger reception power than the other of the antennas 22 registered for hardware diversity A and hardware diversity B is selected by hardware diversity control. With the selected antenna 22, the data signal is received.

Thereafter, at step S47, it is determined whether or not the data signal has been correctly received. If the determined result denotes that the data signal has been correctly received, the flow advances to step S48. At step S48, the normal reception acknowledge signal is transmitted to the radio base station 11.

If the determined result at step S47 denotes that the data signal has not been correctly received, the flow advances to step S49. At step S49, the successive reception failure count is updated by incrementing it by 1.

At step S50, the current successive reception failure count is checked such that it is determined whether or not the current successive reception failure count is larger than the successive reception failure count threshold. If the current successive reception failure count is equal to or smaller than the successive reception failure count, the flow advances to step S43. At step S43, the data signal is received again. In this case, at step S43, every two successive reception failures, the antenna 22 caused to be ready to receive the data signal is switched to be ready to receive the data signal. In other words, if the antenna 22 registered for hardware diversity A has failed to receive the data signal twice in succession, the antenna 22 registered for hardware diversity B is caused to be ready to receive the data signal.

If the determined result at step S50 denotes that the current successive reception failure count is larger than the successive reception failure count threshold, the antenna 22 having a worse radio condition than the other of those registered for hardware diversity A and hardware diversity B is changed to another new antenna by software diversity control. In software diversity control, the results of software calculations of radio information of the antennas 22 registered for hardware diversity A and hardware diversity B are used. As another new antenna 22, an antenna 22 adjacent to the antenna 22 having the better radio condition than the other of the antennas 22 registered for hardware diversity A and hardware diversity B is used.

If a new pair of antennas 22 have been registered for hardware diversity A and hardware diversity B at step S51, the flow advances to step S43. At step S43, the data signal is received from the radio terminal 21 again.

As described above, according to the foregoing embodiment of the present invention, since hardware diversity control is performed with antennas registered for hardware diversity A and hardware diversity B of a plurality of antennas, an antenna having a better radio condition than the other can be selected from these antennas for every packet and it can be received by the selected antenna without a decrease of throughput.

In addition, if radio conditions of antennas registered for hardware diversity A and hardware diversity B have deteriorated, they can be effectively changed to other new antennas by software diversity control. Thus, an antenna can be properly selected corresponding to a communication error state. Since individual antennas are strongly directive, they are less affected by disturbance. Thus, radio communication can be stably performed. As a result, quality deterioration of an HD video and so forth that are transmitted can be suppressed.

It should be understood by those skilled in the art that various modifications, combinations, sub-combinations and alternations may occur depending on design requirements and other factors insofar as they are within the scope of the appended claims or the equivalents thereof. For example, diversity control according to an embodiment of the present invention may be applied to a wireless LAN system other than location free.

What is claimed is:

1. A diversity control method of selecting a plurality of antennas having directivities and disposed in different directions, comprising the steps of:
selecting at least two antennas from the plurality of antennas;
performing first diversity control of comparing strengths of reception powers of the selected at least two antennas and selecting one antenna having a stronger reception power than others; and
performing second diversity control of comparing radio conditions of the at least two antennas in a predetermined period if the radio conditions of the at least two antennas have deteriorated in the first diversity control and changing at least one of the antennas to another new antenna based on a compared result.

2. The diversity control method as set forth in claim 1,
wherein the second diversity control step is performed by changing one antenna having a worse radio condition than the other of the at least two antennas to another new antenna.

3. The diversity control method as set forth in claim 1,
wherein the step of selecting the at least two antennas includes the steps of:
selecting antennas having adjacent directivities; and
selecting the other new antenna as an antenna having a better radio condition than the other of the antennas having the adjacent directivities.

4. The diversity control method as set forth in claim 1,
wherein in the first diversity control, if successive transmission or reception failure counts of the at least two antennas exceed a predetermined threshold, it is determined that radio conditions of the antennas have deteriorated.
